(19) United States
(12) Patent Application Publication
(10) Pub. No.: US 2017/0209239 A1
(43) Pub. Date: Jul. 27, 2017

(54) Method and system for treatment of maxillary deficiency using Hyrax

(71) Applicants: ABDOLRAHMAN SHOWKATBAKHSH, TEHRAN (IR); ABDOLREZA JAMILIAN, TEHRAN (IR)

(72) Inventors: ABDOLRAHMAN SHOWKATBAKHSH, TEHRAN (IR); ABDOLREZA JAMILIAN, TEHRAN (IR)

(21) Appl. No.: 15/007,193

(22) Filed: Jan. 26, 2016

(51) Int. Cl. A61C 7/10

(52) U.S. Cl. CPC A61C 7/10

(57) ABSTRACT

A method and system for treating maxillary transverse discrepancies in young orthodontic patients and in skeletally mature patients. The maxillary protraction device comprises a Hyrax provided with an adjustable screw and four bands connected to the Hyrax through connecting wires.

Placement of Hyrax on first maxillary molars and second maxillary premolars would create enough space for effective treatment of maxillary hypoplasia.

### CROSS-REFERENCE TO RELATED APPLICATIONS

Not Applicable

### STATEMENT REGARDING FEDERALLY SPONSORED RESEARCH OR DEVELOPMENT

Not Applicable

### REFERENCE TO SEQUENCE LISTING, A TABLE, OR A COMPUTER PROGRAM LISTING COMPACT DISC APPENDIX

Not Applicable

### FIELD OF THE INVENTION

This invention relates to a new method of using Hyrax for orthopedic correction of maxillary hypoplasia in non-growing patients.

### BACKGROUND OF THE INVENTION

Maxillary hypoplasia is a condition characterized by transverse, sagittal and vertical maxillary deficiency. Although most class III patients have excess mandibular development, nearly 30-40% have some degree of maxillary deficiency, which is enough to make it a significant etiological factor in skeletal class III malocclusion. In growing subjects with maxillary deficiency where the mandible is not markedly affected, treatment may involve stimulation and guidance of maxillary growth by orthopedic forces. Various types of extra-oral appliances such as facemasks (U.S. Pat. Nos. 4,988,291 and D308,096) and protraction headgears (U.S. Pat. No. 7,121,824) have been used to correct maxillary deficiency. Such extra-oral appliances are particularly unpleasant to wear. In order to overcome this disadvantage De Clerck invented an orthodontic implant (U.S. Pat. No. 7,329,121) which makes it possible to gradually move a person's maxilla to forward position by exerting an almost continuous pressure force or tensile force on the teeth. Jamilian also invented a non-surgical method for correction of maxillary deficiency by means of self-drilling mini-screws and Class III elastics. (U.S. Pat. No. 8,414,291).

However, such treatments are not effective in non-growing patients; therefore, usually surgical corrections such as Le Fort I osteotomy are performed to improve aesthetics and function of non-growing patients suffering from severe maxillary hypoplasia. Higher risk of morbidity, need for a longer surgery time, requirement of fixation, and relapse tendency can be considered as some disadvantages of Le Fort I osteotomy. In addition, during advancement with a Le Fort I osteotomy, there can be some unexpected changes in the nasal construction.

Hang (US. Pat No. 2011/0236847) also used a palatal expansion orthodontic appliance for advancing the upper front teeth. However, Hang's method would only provide dental movement and not skeletal movement.

Recently, distraction osteogenesis was employed in orthopedics and traumatology for treating various congenital and acquired shortenings and other defects or skeletal segments (U.S. Pat No. 4,615,338) Distraction osteogenesis refers to a technique for growing bone by separating two bone segments. External distraction osteogenesis devices are then attached to the bone segments to form a gap between them by exerting pressure between the segments. This technique is also used to lengthen both the maxillary and mandibular arches in patients who have traditionally been difficult to treat with Le Fort I osteotomy.

### BRIEF SUMMARY OF THE INVENTION

To eliminate the problems associated with Le Fort I osteotomy, I have developed a new method. Hyrax is routinely used for lateral expansion of maxilla; nonetheless, in our method it is used to expand the maxilla in anterior and posterior directions. It should be noted that this treatment is only for correction of skeletal problems.

### BRIEF DESCRIPTION OF THE SEVERAL VIEWS OF THE DRAWING

FIG. 1 is a schematic view of the Hyrax according to the invention;

FIG. 2 is a top side view thereof;

FIG. 3 is a bottom view thereof;

FIG. 4 is a rear view thereof;

FIG. 5 is a rear view thereof;

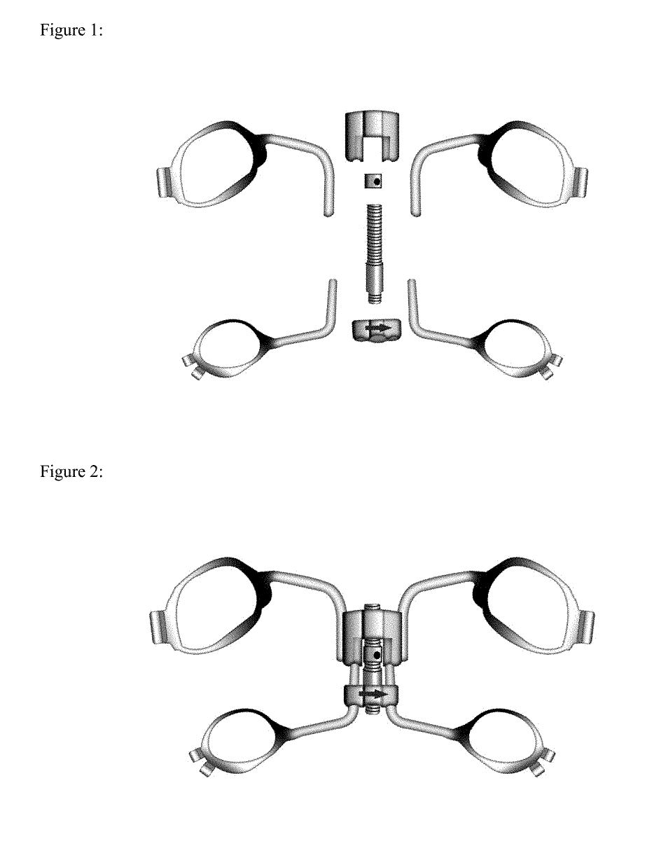

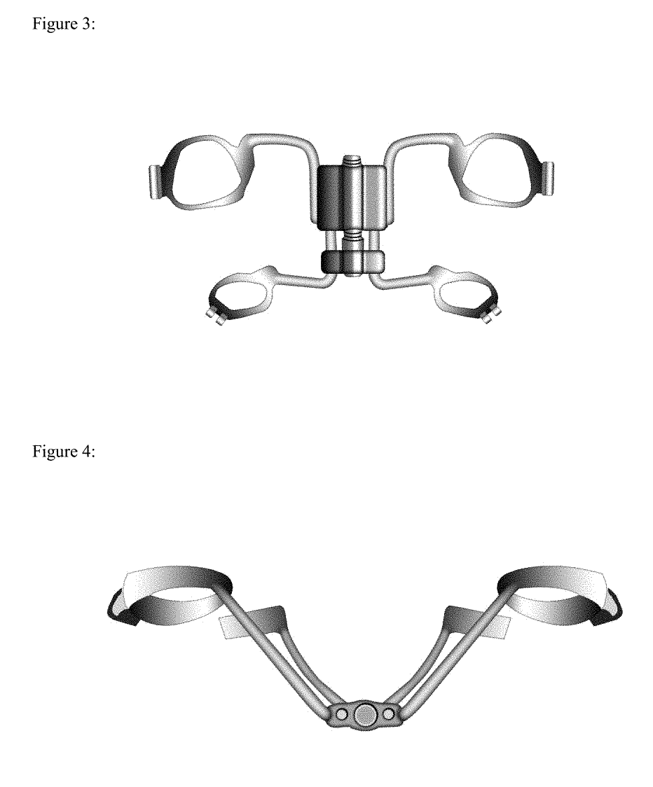

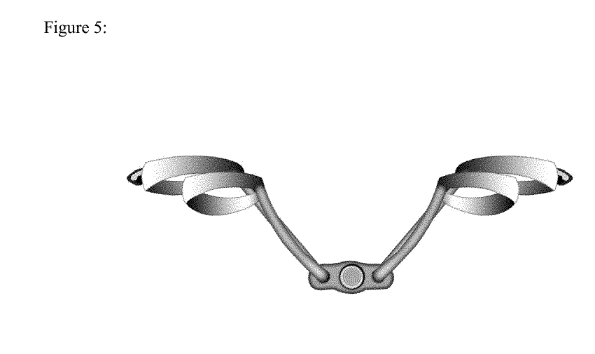

### DETAILED DESCRIPTION OF THE INVENTION

Fixed orthodontics would be used to create 5 mm of space between upper 1^{st} molars and 2^{nd} premolars which would be followed by Le Fort I osteotomy from the right and left space between the first and second upper molars and continued to depth of the sulcus of both sides. Afterwards, the bands of a Hyrax would be placed on the first maxillary molars and second maxillary premolars. The screw of Hyrax would be activated for 12 days creating 12 mm of space. The space created would effectively treat maxillary hypoplasia.

(J Craniofac Surg. 22(4):1361-6, 2011).

1. I claim a new method of application of a Hyrax for correction of maxillary hypoplasia in non-growing patients. Placement of a Hyrax on the first maxillary molars and second maxillary premolars and activation of the screw of the hyrax moves the second premolar anteriorly and the first molar posteriorly and creates the space required for effective treatment of maxillary hypoplasia.
